(19) United States
(12) Patent Application Publication
(10) Pub. No.: US 2014/0217079 A1
(43) Pub. Date: Aug. 7, 2014

(54) SYSTEM FOR SNOW AND ICE REMOVAL

(71) Applicants: James R. NELSON, Annville, PA (US); Todd J. HARTMAN, Hummelstown, PA (US)

(72) Inventors: James R. NELSON, Annville, PA (US); Todd J. HARTMAN, Hummelstown, PA (US)

(21) Appl. No.: 14/245,005

(22) Filed: Apr. 4, 2014

Related U.S. Application Data
(63) Continuation-in-part of application No. 13/174,967, filed on Jul. 1, 2011.
Application No. 13/174,967 is a continuation-in-part of application No. 12/540,468, filed on Aug. 13, 2009, now abandoned.

(51) Int. Cl. B60S 1/66; H05B 3/02

(52) U.S. Cl. CPC B60S 1/66; H05B 3/02
USPC 219/202; 296/136.12

(57) ABSTRACT

A system for removing frozen precipitation that has accumulated on an upper exterior surface of a road vehicle. In an embodiment, the system includes a hydrophobic and/or low friction sheet attached to an upper exterior surface of the road vehicle. The system may further include a heating array attached to the surface and a power source.

This application is a continuation in part of application U.S. patent application Ser. No. 13/174,967, filed Jul. 1, 2011, which priority is claimed and which disclosure is incorporated by reference in its entirety.

### FIELD OF THE INVENTION

The present invention is generally directed to the removal of ice and snow, and more particularly to a system for removing ice and snow from the surface of a truck trailer.

### BACKGROUND OF THE INVENTION

The accumulation of snow and/or ice, hereinafter referred to as “frozen precipitation” on the surface or roof of road vehicles such as vans, trucks, semi-trailer trucks and other large vehicles presents a substantial problem. Frozen precipitation may accumulate on the roof of the vehicle while the vehicle is stopped, parked or otherwise stationary, and may also accumulate on the vehicle roof while the vehicle is moving.

If the frozen precipitation is not removed from the roof of the vehicle, slabs or other solid mass forms of the frozen precipitation may become separated from the vehicle roof and fly off or otherwise fall from the moving vehicle. The flying mass may strike or impact one or more vehicles following behind the moving vehicle, may cause another vehicle to swerve to avoid the flying mass, and/or may form an obstruction on the road surface. In such a manner, the flying and/or obstruction mass may cause damage or lead to an accident. For example, the flying mass may impact and break a windshield of a following car and result in one or more accidents. For at least these reasons, some jurisdictions require that ice and/or snow be removed from a vehicle before the vehicle may travel on roadways.

In some attempts to remove frozen precipitation from the roof of a vehicle, an operator may climb on the roof and remove the frozen precipitation by shoveling, scraping or other similar manual method. For example, see U.S. Patent Pub. No. 2008/0086919, which discloses a scraping device for removing snow from a vehicle. However, such methods represent a substantial safety and cost issue for the operator.

In other attempts, frozen precipitation may be removed from a vehicle roof surface by a static structure that includes a horizontal member that removes the frozen precipitation by scraping the vehicle roof as that the vehicle passes beneath the structure. In yet other attempts, an operator may move the vehicle to or into a facility where the frozen precipitation is removed by heating and/or spraying with de-icing and/or melting agents. However, these attempts are only practical wherein a large number of vehicles are present so as to justify the expense thereof. They do not provide a solution for a single or few vehicles that can be in a location wherein such a structure is not available.

Thus, a long felt need exits to economically remove frozen precipitation from a surface of a road vehicle.

What is needed is a system and method to remove frozen precipitation from the roof of a road vehicle, and in particular to remove frozen precipitation from a large vehicle such as a tractor-trailer.

### SUMMARY OF THE INVENTION

A first aspect of the disclosure includes a snow and ice removal system for removing frozen precipitation from an exterior surface of a vehicle, including a sheet substantially overlaying an upper exterior surface of a tractor-trailer or box truck. The sheet including a polymer layer applicable by spraying having a low coefficient of friction relative to a solid in contact with the upper exterior surface of the tractor-trailer.

A second aspect of the disclosure a tractor-trailer including an upper exterior surface and a frozen precipitation removal system affixed to the exterior surface. The frozen precipitation removal system including a polymer sheet attached to the upper exterior surface of the tractor trailer, the sheet having a low coefficient of friction relative to a solid in contact with the upper exterior surface of the tractor-trailer. A plurality of fasteners configured to attach the polymer sheet to the upper exterior surface.

A third aspect of the disclosure includes a snow and ice removal system for removing frozen precipitation from an external surface of a vehicle, including a polymer layer having a low coefficient of friction relative to a solid in contact with the layer and substantially overlaying an upper external surface of a tractor-trailer. The layer is a coating applied by spraying onto the upper external surface of the tractor-trailer.

A fourth aspect of this disclosure a tractor-trailer including an upper surface, wherein the upper surface defines a curved geometry wherein at least side edges of the upper surface are positioned below the rest of the upper surface.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates a perspective view of a tractor trailer having an exemplary embodiment of a snow and ice removal system according to the invention installed thereupon.

FIG. 2 illustrates a perspective view of a tractor trailer having another exemplary embodiment of a snow and ice removal system according to the invention installed thereupon.

FIG. 3 illustrates a perspective view of a tractor trailer having another exemplary embodiment of a snow and ice removal system according to the invention installed thereupon.

FIG. 4 schematically illustrates an exemplary embodiment of an exemplary embodiment of a snow and ice removal system according to the invention installed thereupon.

### DETAILED DESCRIPTION OF THE INVENTION

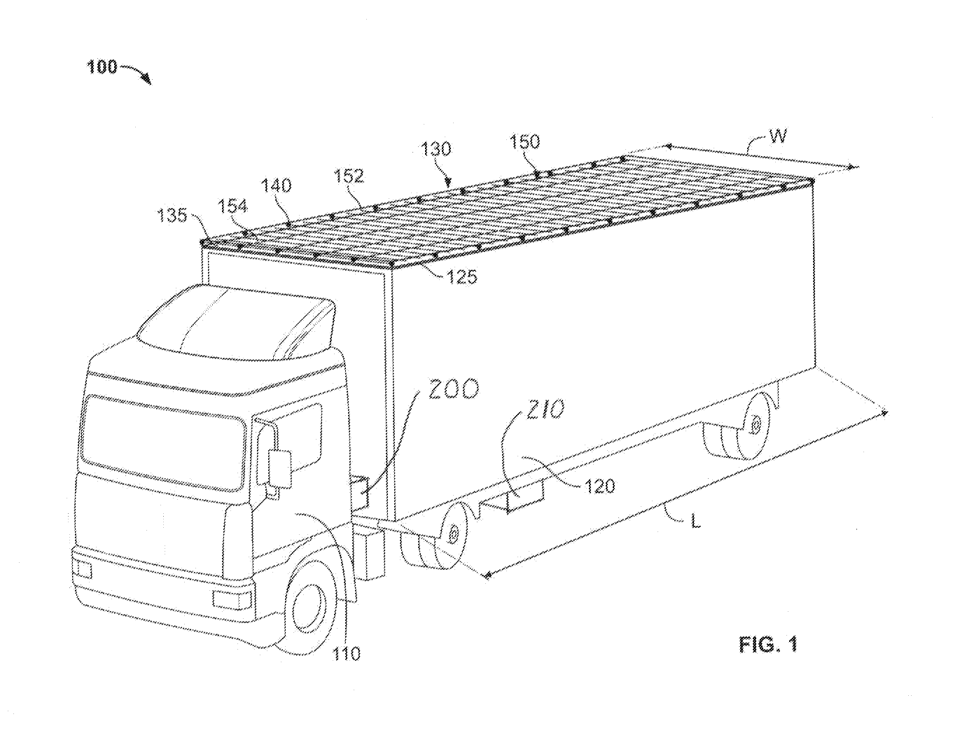

FIG. 1 illustrates a road vehicle 100 including a towing engine or trailer 110 and a semi-trailer 120 having an exemplary embodiment of a snow and ice removal system (system) 130 according to the disclosure attached thereto. Within this disclosure, the term “snow and ice” includes any form of frozen precipitation, including, but not limited to snow, ice, sleet, freezing rain and hail. Furthermore, in this exemplary embodiment, the road vehicle is a tractor trailer. However, in other embodiments, the road vehicle 100 may be any vehicle, motorized or non-motorized, that travel on a road, such as, but not limited to box trucks, trailers, semi-trailers, towed oversized structures including housing structures and mobile homes.

As further shown in FIG. 1, the system 130 includes a layer or sheet 135 of a material that incorporates a heating array 150 and a power source (not shown). The heating array 150 is contained within or disposed within the sheet 135. In another embodiment, the heating array 150 may be attached on the upper surface and/or underneath the surface and/or embedded within the sheet 135. In one embodiment in which the sheet 135 is underneath and/or at least partially embeds the heating array 150 and at least partially overlies a surface 125 of the semi-trailer 120, the sheet 135 thermally insulates and directs thermal energy away from the surface for removing ice and snow from the sheet 135. In one embodiment, the sheet used has a brand name of Infra-Stop® to keep heat from entering the interior of trailer load or cargo area. A thin Mylar® sheet can be placed over the heating grid/array to aid in even distribution of heat throughout the exposed exterior top surface sheet. In one embodiment, the Mylar® sheet can be an aluminized Mylar® sheet, having, for example, but not limited to a thickness of 0.0018 inch or other sufficient thickness. In one embodiment, layer or sheet 135 can be a coating applied beneath or over the heating array. In another embodiment, the heating array is not contained within or disposed within a sheet and is installed over a conventional semi-trailer or other vehicle.

The sheet 135 may be formed of metal, such as aluminum, polymer or composite material or combination thereof having a low coefficient of friction against a solid and/or be hydrophobic. In one embodiment, sheet 135, such as a metal can have a surface treatment such as polishing to achieve the low coefficient of friction. In one embodiment, the sheet, such as a metal sheet, such as aluminum sheet, includes an overlying layer having a low coefficient of friction. In an embodiment, the sheet 135 may be formed of fluoropolymer, such as polytetrafluoroethylene (PTFE). PTFE is most well known by the DuPont brand name Teflon™. PTFE is a fluorocarbon solid, a high-molecular-weight compound consisting wholly of carbon and fluorine. PTFE is hydrophobic: neither water nor water-containing substances wet PTFE, as fluorocarbons demonstrate mitigated London dispersion forces due to the high electronegativity of fluorine. PTFE has one of the lowest coefficients of friction against any solid. As can be seen in FIG. 1, the sheet 135 and/or heating array 150 is attached to a surface 125 of the semi-trailer 120. In this exemplary embodiment, the surface 125 is the horizontal planar roof of the semi-trailer 120. In another embodiment, the surface 125 may be an upper surface of the semi-trailer 120. In another embodiment, the surface 125 may be non-planar. For example, the surface 125 may be stepped or otherwise discontinuous, or may be curved. In another embodiment, the surface 125 may include ridges or other non-planar elements.

The sheet and/or heating array 150 is attached to the surface 125 by fasteners 140. The fasteners 140 may be, but are not limited to, rivets, clips, loops, anchor hooks, hasps or other retainers. The fasteners 140 may detachably attach or permanently affix the system 130 to the surface 125. In one embodiment, the fasteners 140 are detachable from the surface 125. For example, the fasteners 140 may be detachably received in slots in the surface 125 or bolted to the surface 125. In another embodiment, the fasteners 140 are permanently affixed to the surface 125, such as by rivets. For example, the fasteners 140 may be molded into or welded to the surface 125. In one embodiment, the fasteners 140 allow the heating array 150 to be detached from the surface 125. The fasteners 140 retain the sheet 135 and/or heating array 150 in substantial contact with the surface 125.

In this exemplary embodiment, the surface 125 is substantially planar or flat, however, in other embodiments, the surface 125 may be ridged or otherwise non-planar. In another embodiment, the heating array 150 contacts the surface 125 at contact points. In yet another embodiment, the surface 125 may include channels, slots, grooves, toughs or other receiving features (not shown) for at least partially supporting and/or containing the sheet 135 and/or heating array 150.

The heating array 150 includes a plurality of resistive heating elements 152 electrically connected in parallel across the width W of the semi-trailer 120. The resistive heating elements 152 may be electric cable having a hot insulated conductor.

The heating array 150 may include an array of support lines 154 provided across the length L of the semi-trailer 120. The support lines 154 space the resistive heating elements 152 at a predetermined fixed spacing across the semi-trailer 120. In one embodiment, the support lines 154 may be an elastic web or film. For example, the support lines 154 may be formed of a heat-resistant polymer web material. The support lines 154 may be formed of a Teflon™ web or film.

In this exemplary embodiment, the sheet 135 and heating array 150 are provided across the length L of the semi-trailer 120 and width W of the semi-trailer. In another embodiment, the sheet 135 and/or heating array 150 are provided across a portion of the length L and/or width W of the semi-trailer. The sheet 135 and/or heating array 150 may include locking devices (not shown) to securely affix the sheet 135 and/or heating array to the semi-trailer 120.

The sheet 135 and/or heating array 150 may be assembled to the surface 125 at the time of new assembly of the semi-trailer 120. In yet another embodiment, the sheet 135 and/or heating array 150 is retro-fitted or otherwise later added to the semi-trailer 120 after the manufacture of the semi-trailer 120.

In one embodiment, the heating array 150 is electrically connected to a power source 200 via an electrical wire or cable (not shown). In other embodiments, power source 200 may be located in other positions in/on or remotely located from trailer 110 and/or semi-trailer 120. The electrical cable may be permanently attached or detachable from the heating array 150. In another embodiment, the electrical cable is attached to the power source and connected to the heating array 150. In one embodiment, an electrical power safety device (not shown) may be electrically disposed between the heating array 150 and the power source. The electrical power safety device would break or disconnect the positive or hot wire connection.

In one embodiment, the power source 200 is an APU Auxiliary Power Unit or portable generator that is electrically connected to the heating array 150. The power source 200 may or may not include the electrical cable used to attach the power source 200 to the heating array. In one embodiment, the portable generator may have an electrical output of about 15 kW. The APU or portable generator may be gasoline or diesel fuel powered within the truck system.

In another embodiment, the power source 200 may be an APU unit. The APU may be carried by the road vehicle 100 or may be provided at a stationary location.

In one embodiment, the power source 200 provides electrical energy to the heating array 150 to produce about 0.25 watt per square inch. The heat density could be increased to between about 1.0 to about 3.0 watt per square inch with using a larger power source 200 from an APU or generator having a sufficiently increased electrical output. In another embodiment, the system 130 further includes a temperature control unit (not shown) to control the heat generated by the heating array 150. In another embodiment, the power source is an APU, electrical supply point, such as an electrical outlet or an electrical source, such as a power panel, to which the electrical cable is attached. The power source provides electricity to the heating array 150 to substantially melt and thus remove any frozen precipitation that has accumulated on the surface 125 before the tractor trailer or vehicle 100 begins to travel.

In another embodiment, the power source for supplying power to the heating array 150 is one or more additional alternators, such as driven by one or more drive belts of the motor of vehicle 100. In an alternate embodiment, an SMPS (switch mode power supply) system or SMPS 210 can be used as supplemental switch mode power to be plugged in to the docking station/ trucking port for heating of trailer top without running the truck engine. The SMPS 210 can be located/attached directly under the trailer for use when the trailer is detached from the engine cab. SMPS 210 can be used to convert available power options (240 volt, 480 volt, single phase, three phase, etc.) from the docking station to the proper voltage and current levels required by the heating system.

In another embodiment, the power source can be one or more of the APU, generator(s), alternator(s), truck motor or any combination thereof.

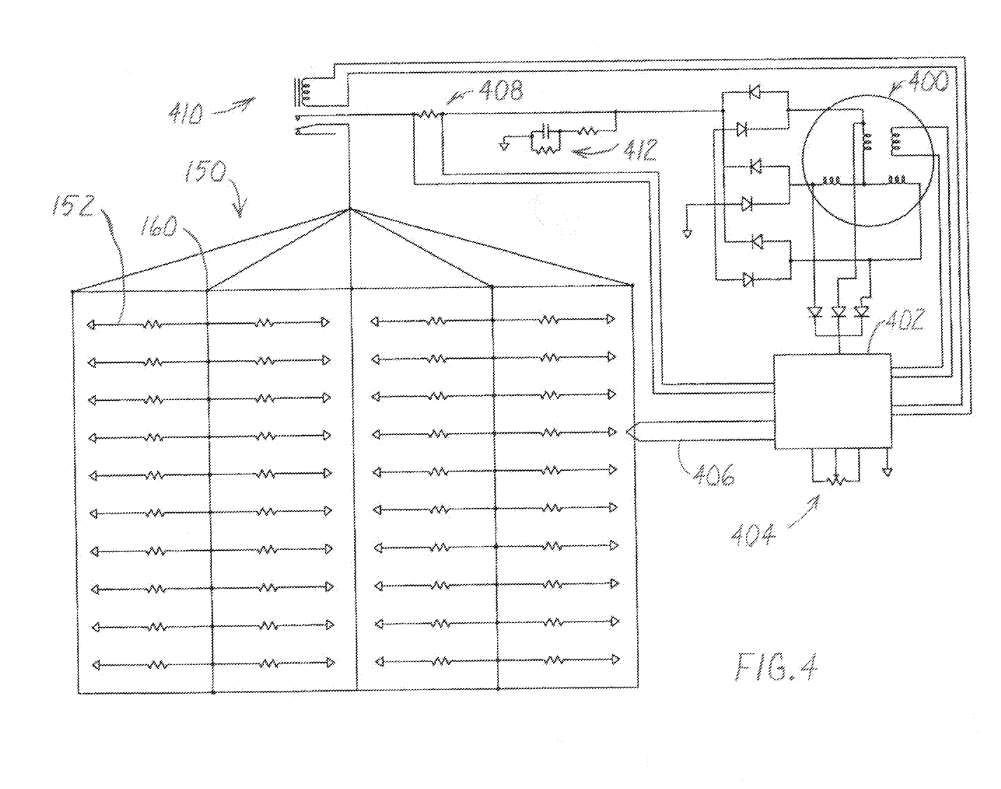

FIG. 4 schematically illustrates an embodiment of the system 130. As further shown in FIG. 5, an alternator 400, such as powered by the motor of trailer 110 (FIG. 1) generates electrical power to heat heating elements 152 of heating array 150, such as resistive heating elements comprised of NiChrome ribbon wire, Kanthal® ribbon and/or silver loaded carbon film, or other suitable material. Insulation for the wire may be comprised of Kapton®, polyethylene terephthalate (PET), Mylar® or other suitable material for providing substantially uniform heating by the heating array 150. Resistance of wire varies depending on wire length and layout geometry. Electrical power generated by alternator 400 is regulated by voltage regulator 402, which voltage regulator 402 also operates to limit an amount of current provided to the heating array 150 that is in excess of predetermined settings.

For example, in one embodiment, voltage regulator 402 limits the voltage of the system to 28 V, in order to prevent lethal amounts of current flow to the human body in case of an accident. In another embodiment, the amount of the voltage may be different than 28 V, with attention to keeping the voltage limited to 28 volts, would be within commonly accepted safety standards, such as set by Underwriters Laboratories (UL). In one embodiment, in view of Ohm's Law, in which voltage equals the product of current (I; measured in amperes) and resistance (R; measured in ohms), for a predetermined, unchanging voltage, it is appreciated by one having skill in the art that current can be increased accompanied by a correspond reduction in resistance. Voltage regulator 402 monitors inputs such as a call for heat adjustment 404 that is then compared to the existing temperature of heating element 152 via a temperature feedback arrangement 406. The call for heat adjustment 404 may be input by an operator (e.g., vehicle driver) or in response to one or more of a predetermined ambient temperature surrounding the vehicle or a predetermined drop in the ambient temperature over a predetermined period of time. As further shown in FIG. 4, the voltage regulator 402 monitors a current sensor 408 that senses the amount of current flowing in the system, which voltage regulator 402 is configured to selectively reduce the amount of electrical power provided to the heating array 150, or to completely disconnect electrical power provided to the heating array 150, such as by selective control of a relay 410.

In one embodiment, the power source generally needs to generate about 15-15.5 KW of electrical power to sufficiently heat a heating array for ice and snow removal from a semi-trailer top surface the for covering, such as 53 feet by 102 inches, or approximately 0.25 W/in², such as when the sheet 135 thermally insulates and directs thermal energy away from the surface 125 (FIG. 1) for more efficient heating for removal of snow and ice from the semi-trailer top surface. It is to be understood that the system may be configured to generate sufficient electrical power that may be different from 15.5 kW (less than, or greater than 15.5 kW, such as 20 kW, 26 kW, 30 kW, etc.) to heat one or more heating array(s), which may or may not be interconnected to one another, such as for use with tandem trailers or other multiple trailer arrangement that may total an amount of surface area greater than an area covering 53 feet by 102 inches.

As further shown in FIG. 4, system 130 includes a load dump snubber 412, also referred to as a snubber, snubber network, snubber subsystem, or the like, providing further safety from voltage transients, also referred to as voltage spikes. That is, in one situation, a voltage transient may be produced by the inductance of the alternator when the load is suddenly disconnected. Alternately, a voltage transient may result from a “bad” (e.g., intermittent) connection or accidental disconnection of the heating array 150 occurring during operation of the system. Without the load dump snubber 412, the alternator voltage can spike to 120 V or more. The snubber 412 will dissipate or otherwise absorb the voltage transient.

The distributed arrangement of nodes 160 (FIG. 4) to the heating elements 152 of the heating array 150 provides alternate power paths to heating elements 152 and/or to different portions of the heating array 150 in case some of the power paths are destroyed (damaged from punctures, crushing, shearing, etc). Depending on which section(s) or portion(s) of the heating array 150 is destroyed, as a general matter, the system may be able to withstand a loss of from about less that 1 percent to about 25 percent of the total heating capacity, and continue to operate melting ice and snow. When some of the heating surface becomes damaged (from punctures, etc.) the system can automatically increase the heating density to the remaining working areas of the heating mat. The regulator can sense the resistance of the heating elements and increase the voltage (thus power) to the remaining undamaged areas after damage has occurred to some sections of the mat. This additional heat to the undamaged areas may help compensate for the damaged (cold) areas.

In summary, the system includes an over-current detection scheme and arc faults that will immediately disconnect power to the heating array 150. As previously discussed, the system further includes a temperature feedback system or temperature feedback arrangement 406 to regulate voltage output and thus the heating level of the heating array 150 in a manner that enhances safety during operation of the system.

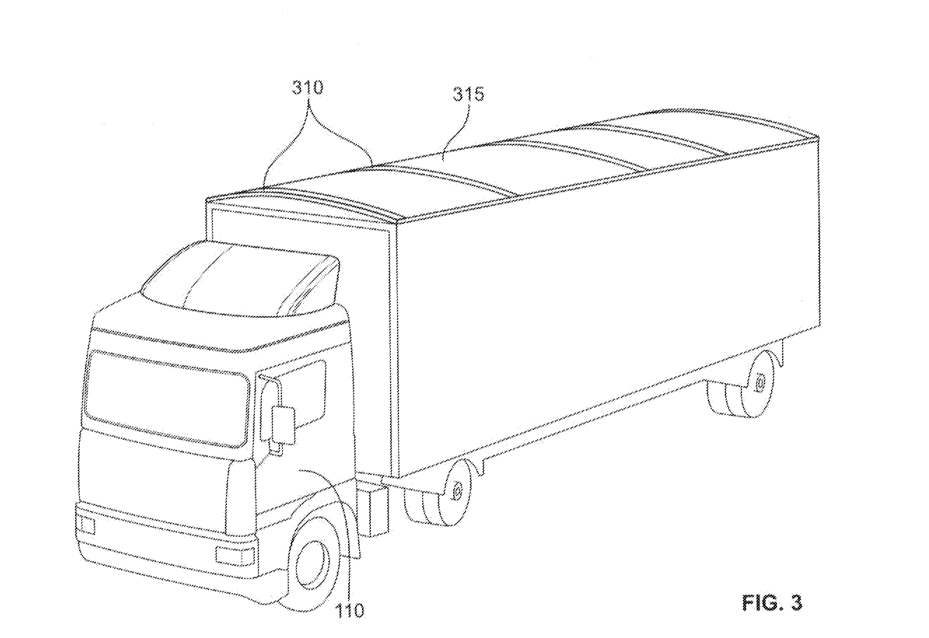

FIG. 3 illustrates another embodiment of the system 130, including an upper or top surface 315 of the tractor-trailer supported by bow supports 310. Optionally, the sheet 135 and heating array 150 (FIG. 1) can be included and would also be supported by bow supports 310. In an embodiment, the sheet 135 and heating array 150 may be supported by one or more bow supports 310. The bow supports 310 support the sheet 135 and heating array 150 in a curved, bowed, or otherwise domed geometry, which assists in shedding, sliding, or removing snow or ice from the sheet 135. In another embodiment, the surface 315 may be bowed or curved to support the sheet 135 and heating array 150 in a bowed configuration or profile. In another embodiment, the bowed sheet 135 does not include heating array 150. As shown, the upper or top surface 315 is bowed or curved such that the side edges of the top surface are positioned below the rest of the top surface. In a further embodiment, sheet 135 is bowed such that all peripheral edges of the sheet overlaying the top of the tractor-trailer are lower than the rest of the surface of the tractor-trailer. In a further embodiment, the curved, or bowed or domed upper or top surface 315 of the tractor-trailer does not include the sheet and heating array as shown in FIG. 1. In a further embodiment, the curved, or bowed or upper or top surface 315 of the tractor-trailer includes a coating layer, such as a sprayed on layer of material having a low coefficient of friction, such as PFTE.

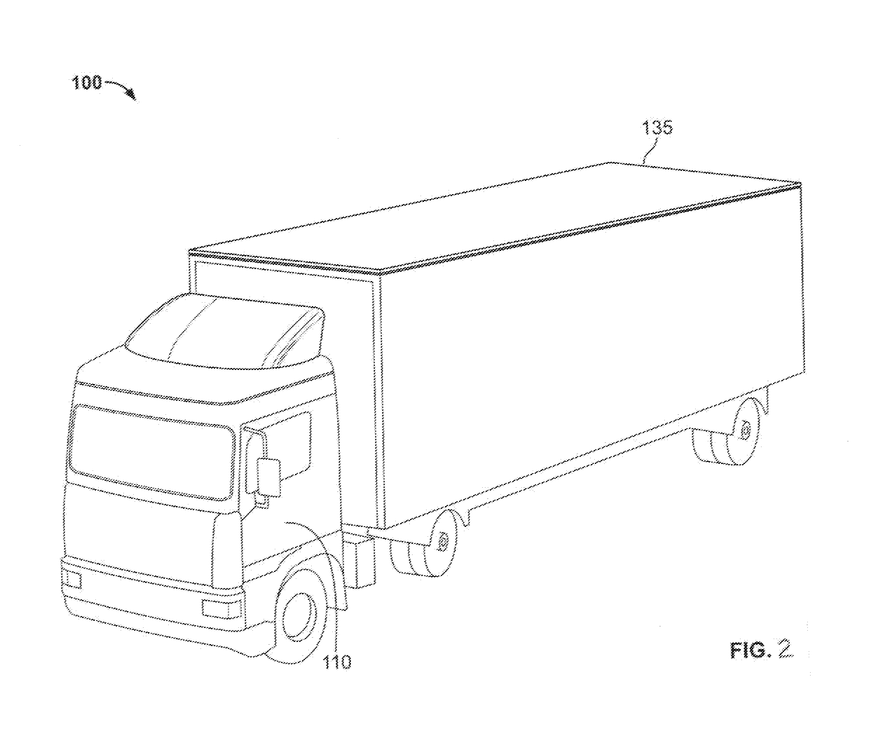

FIG. 2 illustrates another embodiment of the system 130. In this exemplary embodiment, the system 130 includes the sheet 135, and no heating array 150. The sheet 135 is attached to the surface 125, which has a substantially flat profile. In another embodiment, the sheet 135 may be flat or have a bowed profile as discussed in regard to FIG. 3 above. In another embodiment of system 130, a layer 235 of material is applied to the upper surface of the tractor trailer 110. In another embodiment of system 130, layer 235 of material comprises a coating. In a further embodiment of the system 130, layer 235 is formed by a spraying technique including, but not limited to, an air pressure spray system, a mechanical brush system or manual brush technique. In yet another embodiment of the system 130, the upper surface of the tractor trailer is curved, as previously discussed.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A snow and ice removal system for removing frozen precipitation from an exterior surface of a vehicle, comprising:
a sheet substantially overlaying an upper exterior surface of a tractor-trailer or box truck, the sheet including a polymer layer applicable by spraying having a low coefficient of friction relative to a solid in contact with the upper exterior surface of the tractor-trailer.

2. The system of claim 1, further comprising:
a plurality of fasteners configured to attach the polymer sheet to the upper exterior surface.

3. The system of claim 1, wherein the sheet is formed of polytetrafluoroethylene.

4. The system of claim 1, further comprising a heating element in contact with the polymer sheet.

5. The system of claim 4, further comprising a power source configured to provide electrical power to the heating element and generate heat.

6. The system of claim 4, wherein the heating element comprises a resistive heating element.

7. The system of claim 5, wherein the power source is at least one of APU, generator or alternator or combination thereof powered by a vehicle motor, a voltage generated by the power source being about 28 V, and further including a snubber subsystem to reduce voltage transients.

8. The system of claim 1, wherein the sheet defines a curved geometry supported by one or more bow supports.

9. The system of claim 8, wherein at least side edges of the overlaid tractor-trailer surface are positioned below the rest of the tractor-trailer surface.

10. The system of claim 1, wherein the sheet defines a domed geometry supported by one or more bow supports.

11. A tractor-trailer comprising,
an upper exterior surface;
a frozen precipitation removal system affixed to the exterior surface, the frozen precipitation removal system comprising a polymer sheet attached to the upper exterior surface of the tractor trailer, the sheet having a low coefficient of friction relative to a solid in contact with the upper exterior surface of the tractor-trailer; and
a plurality of fasteners configured to attach the polymer sheet to the upper exterior surface.

12. The tractor-trailer of claim 11, wherein the sheet is formed of polytetrafluoroethylene.

13. The tractor-trailer of claim 11, further comprising a heating element in contact with the polymer sheet.

14. The tractor-trailer of claim 13, further comprising a power source configured to provide electrical power to the heating element and generate heat.

15. The tractor-trailer of claim 13, wherein the heating element comprises a resistive heating element.

16. The tractor trailer of claim 14, wherein a distributed arrangement of nodes to heating elements of a heating array provide alternate power paths to heating elements and/or to different portions of the heating array in response to damage to a portion of the heating array.

17. A snow and ice removal system for removing frozen precipitation from an external surface of a vehicle, comprising
a polymer layer having a low coefficient of friction relative to a solid in contact with the layer and substantially overlaying an upper external surface of a tractor-trailer;
wherein the layer is a coating applied by spraying onto the upper external surface of the tractor-trailer.

18. The system of claim 17, wherein the upper exterior surface of the tractor-trailer defines a curved geometry supported by one or more bow supports.

19. A tractor-trailer comprising
an upper exterior surface,
wherein the upper exterior surface defines a substantially rigid curved geometry supported by one or more bow supports, wherein at least side edges of the upper exterior surface are positioned below the rest of the upper exterior surface to assist in removing snow or ice from the upper exterior surface, and wherein the tractor-trailer comprises a heating element.

20. The tractor-trailer of claim 19, further comprising
a polymer sheet substantially overlaying an upper exterior surface of the tractor-trailer, the sheet having a low coefficient of friction relative to a solid in contact with the upper exterior surface of the tractor-trailer; and
a plurality of fasteners configured to attach the polymer sheet to the upper exterior surface.

21. The tractor-trailer of claim 19, wherein the upper exterior surface comprises an aluminum sheet.
